(19) United States
(12) Patent Application Publication
(10) Pub. No.: US 2013/0127726 A1
(43) Pub. Date: May 23, 2013

(54) APPARATUS AND METHOD FOR PROVIDING USER INTERFACE USING REMOTE CONTROLLER

(71) Applicants: Byung-youn Song, Suwon-si (KR); Nag-eui Choi, Suwon-si (KR)

(72) Inventors: Byung-youn Song, Suwon-si (KR); Nag-eui Choi, Suwon-si (KR)

(21) Appl. No.: 13/674,818

(22) Filed: Nov. 12, 2012

(30) Foreign Application Priority Data
Nov. 23, 2011 (KR) 10-2011-0123121

(51) Int. Cl. G06F 3/01; G06F 3/02; G06F 3/041

(52) U.S. Cl. CPC G06F 3/01; G06F 3/041; G06F 3/02
USPC 345/168; 345/156; 345/173

(57) ABSTRACT

Described is an apparatus and method for providing a graphic user interface. A main body of the apparatus may provide a plurality of user interfaces on a display and a remote controller of the apparatus may provide a plurality of user interfaces on the remote controller. A user interface provided by the main body may be synchronized with a user interface provided on the remote controller for the convenience of the user.

### CROSS-REFERENCE TO RELATED APPLICATION(S)

This application claims the benefit under 35 USC §119(a) of Korean Patent Application No. 10-2011-0123121, filed on Nov. 23, 2011, in the Korean Intellectual Property Office, the entire disclosure of which is incorporated herein by reference for all purposes.

### BACKGROUND

1. Field

The following description relates to apparatuses and methods for providing a user interface using a remote controller, and more particularly, to apparatus and methods for providing a user interface based on use characteristics of a user using the remote controller.

2. Description of Related Art

A user interface allows a user to easily manipulate and use digital apparatuses. Recently, various smart functions such as Internet, games, social networking services, and the like, have been introduced in digital apparatuses such as Blu-ray players, multimedia players, set top boxes, and the like. Data may be input through a user interface of the digital apparatuses to manipulate the digital apparatuses.

For example, in order to quickly and intuitively transmit data to a user, a graphic user interface may be used. In the graphic user interface, the user may move a pointer using a keypad, a keyboard, a mouse, a touch screen, and the like, and may select an object indicated by the pointer to direct a desired operation to the digital apparatus.

Typically, a remote controller is used to remotely control a digital apparatus such as television, a radio, a stereo, a Blu-ray player, and the like. In a typical remote controller, several function keys (e.g., channel number, volume keys, power keys, etc.) are provided and manipulated to control digital apparatuses. As digital apparatuses become multi-functional, additional inputs to a remote controller are required to control electronic devices. Accordingly, some remote controllers include so many key buttons which are added for various inputs that it causes the key buttons to become overloaded, or which creates a complicated menu system.

### SUMMARY

Provided is an apparatus for providing a user interface, the apparatus including a main body configured to provide a plurality of user interfaces on a display, and a remote controller configured to provide a plurality of user interfaces on the remote controller, wherein, in response to a user interface on the remote controller being selected, the main body is configured to provide a user interface on the display that corresponds with the selected user interface on the remote controller.

The main body may comprise a display unit which includes the display, a communication unit configured to receive a control command from the remote controller, and a user interface control unit configured to provide a graphic user interface to the display unit.

The remote controller may comprise an input unit configured to receive input from a user, a user interface control unit disposed on a surface of the remote controller and configured to provide a plurality of user interfaces, a control command generating unit configured to generate a control command according to a signal of a user input to the input unit, and a communication unit configured to transmit the control command to the main body.

The input unit may comprise a touch screen.

The remote controller may comprise a selection key configured to receive input from a user to manually select a user interface that is to be provided on the remote controller from among the plurality of user interfaces.

The apparatus may further comprise a sensor unit configured to detect a manner in which a user is holding the remote controller, wherein the user interface on the remote controller is converted or maintained based on the manner in which the user is holding the remote controller.

The user interface control unit of the remote controller may be configured to provide a first user interface including a graphic of a keyboard formed by combining number keys and function keys, in response to detecting that the user is holding the remote controller with one hand, and the user interface control unit of the remote controller may be configured to provide a second user interface including a graphic of a QWERTY keyboard of the remote controller, in response to detecting that the user is holding the remote controller with two hands.

The plurality of user interfaces provided by the main body may comprise a first user interface and a second user interface which are provided based on the same operating system.

The first user interface and the second user interface may be provided by the main body comprise manipulation menu systems corresponding to each other.

The remote controller may further comprise a motion sensor configured to detect motion of the remote controller, and in response to the motion sensor detecting movement of the remote controller satisfying a predetermined conversion pattern, a user interface provided by the main body is converted between the first user interface and the second user interface.

The main body may comprise a smart television.

In an aspect, there is provided a method of providing a user interface, the method including selecting and providing one of a plurality of user interfaces on the remote controller, and providing, by a main body, one of a plurality of user interfaces on a display unit, wherein the main body provides the user interface on the display to correspond to the selected user interface provided on the remote controller.

The user interface on the remote controller may be selected manually by direct manipulation of a user.

One of the plurality of user interfaces on the remoter controller may be selected automatically based on a manner in which a user is holding the remote controller.

The selecting and providing of the user interface on the remote controller may comprise detecting whether the user is holding the remote controller with one hand or with two hands, and maintaining the user interface of the remote controller or converting the user interface of the remote controller to another user interface from among the plurality of user interfaces of the remoter controller based on whether the user is holding the remote controller with one hand or with two hands.

A first user interface on the remote controller may comprise a graphic of a keyboard formed by combining number keys and function keys, in response to detecting that he user is holding the remote controller with one hand, and a second user interface on the remote controller may comprise a graphic of a QWERTY keyboard, in response to detecting that the user is holding the remote controller with two hands.

The plurality of user interfaces provided by the main body may comprise a first user interface and a second user interface both of which are provided based on the same operating system.

The first user interface and the second user interface may comprise manipulation menu systems corresponding to each other.

The method may further comprise converting between the first user interface and the second user interface in response to motion of the remote controller satisfying a predetermined conversion pattern.

In an aspect, there is provided an apparatus for providing a user interface, the apparatus including a main body configured to provide a plurality of user interfaces on a display, and a remote controller configured to provide a plurality of user interfaces on the remote controller, wherein, in response to a user interface provided by the main body on the display being selected, the remote controller is configured to provide a user interface on the remoter controller that corresponds with the selected user interface provided by the main body on the display.

Other features and aspects may be apparent from the following detailed description, the drawings, and the claims.

### BRIEF DESCRIPTION OF THE DRAWINGS

FIG. 1 is a diagram illustrating an example of a multimedia apparatus.

FIG. 2 is a diagram illustrating an example of a remote controller used with the multimedia apparatus of FIG. 1.

FIG. 3 is a diagram illustrating another example of the multimedia apparatus of FIG. 1.

FIG. 4 is a diagram illustrating an example of a user interface of the multimedia apparatus of FIG. 1.

FIG. 5 is a diagram illustrating another example of a user interface of the multimedia apparatus of FIG. 1.

FIG. 6 is a flowchart illustrating an example of a method of providing a user interface in the multimedia apparatus of FIG. 1.

FIG. 7 is a flowchart illustrating another example of a method of providing a user interface in the multimedia apparatus of FIG. 1.

FIG. 8 is a diagram illustrating another example of a multimedia apparatus.

FIG. 9 is a diagram illustrating an example of a remote controller used in the multimedia apparatus of FIG. 8.

FIG. 10 is a diagram illustrating another example of the multimedia apparatus of FIG. 8.

FIG. 11 is a diagram illustrating an example of a user interface of the multimedia apparatus of FIG. 8.

FIG. 12 is a diagram illustrating another example of a user interface of the multimedia apparatus of FIG. 8.

FIG. 13 is a flowchart illustrating another example of a method of providing a user interface in the multimedia apparatus of FIG. 8.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

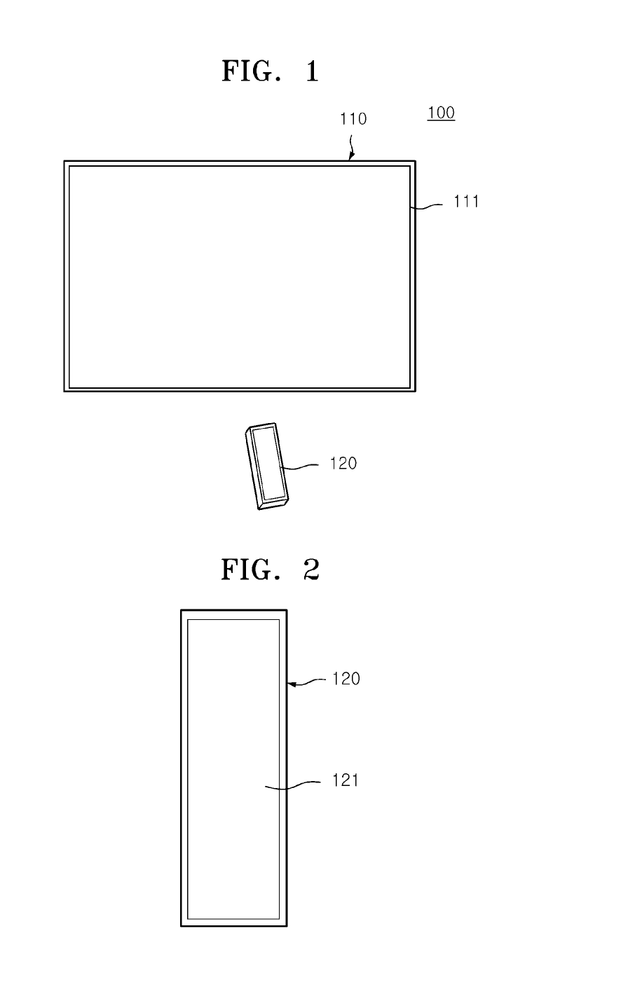

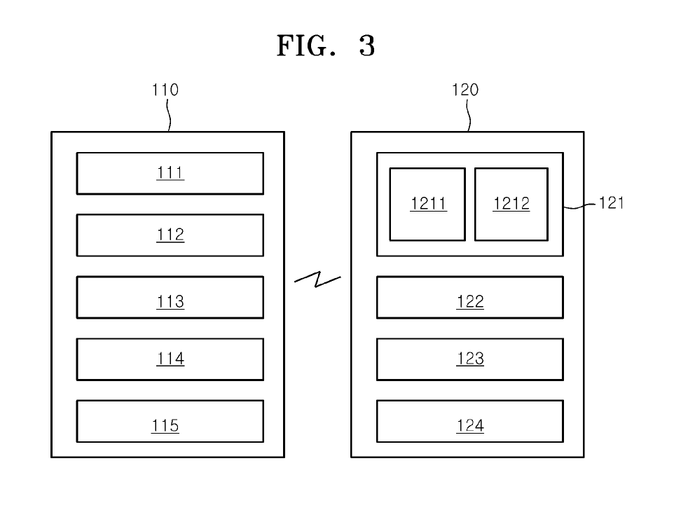

FIG. 1 illustrates an example of a multimedia apparatus 100. FIG. 2 illustrates an example of a remote controller 120 used with the multimedia apparatus 100 of FIG. 1. FIG. 3 illustrates another example of the multimedia apparatus 100 of FIG. 1.

Referring to FIGS. 1 through 3, the multimedia apparatus 100 includes a main body 110 and a remote controller 120 that is used to control the main body 110.

The main body 110 may include a display unit 111, a data input unit 112 that may receive data from an outside source, a signal processing unit 113 that may process the input data, a communication unit 114 on the host side, that may communicate with the remote controller 120, and a user interface control unit 115 on the host side.

For example, the main body 110 may be a smart television that includes an operating system and that is capable of sensing not only public wave broadcasting or cable broadcasting but also accessing the Internet and executing various programs. Smart televisions may include an operating system and internet access so that real-time broadcasting may be watched, and various contents such as video on demand (VOD), games, searching, and convergence or user intelligence services may also be used (UI/UX).

As another example, the main body 110 may be a device such as a Blu-ray player, a multimedia player, a set top box, a personal computer, a game console, and the like, in which the display unit 111 is mounted inside or outside thereof.

The display unit 111 may include a display panel such as a liquid crystal panel, an organic light-emitting panel, and the like, which may be used to display graphics of a user interface indicating various functions, such as function setup, software applications, and contents such as music, photographs, and videos.

The data input unit 112 is an interface through which the data, such as the data to be displayed on the display unit 111, may be input. For example, the data input unit 112 may include at least one of a universal serial bus (USB), a parallel advanced technology attachment (PATA), a serial advanced technology attachment (SATA), a flash media, Ethernet, Wi-Fi, Bluetooth, and the like. According to various aspects, the main body 110 may include a data storage device (not shown) such as an optical disk drive or a hard disk.

The signal processing unit 113 may decode data that is input via the data input unit 112.

The communication unit 114 on the host side may receive a control command from the remote controller 120. For example, the communication unit 114 may include a communication module such as an infrared communication module, a radio communication module, an optical communication module, and the like. As an example, the communication unit 114 may include an infrared communication module satisfying an infrared data association (IrDA) protocol. Alternatively, the communication unit 114 may include a communication module using a 2.4 GHz frequency or a communication module using Bluetooth.

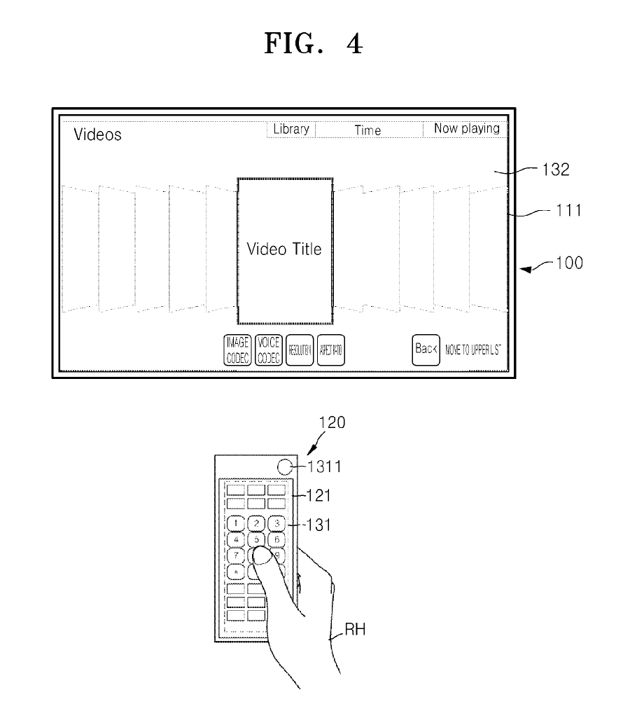

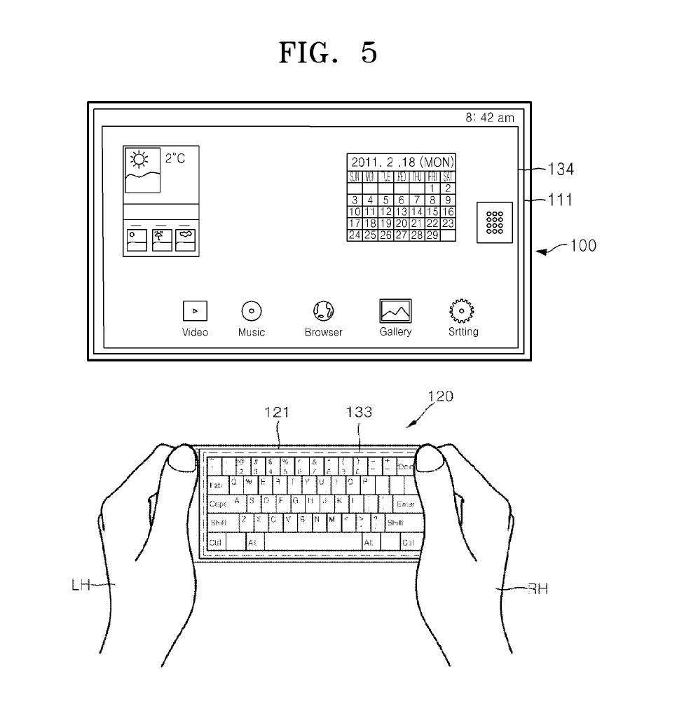

The user interface unit control unit 115 may provide a plurality of user interfaces on the host side based on an operating system (OS) of the main body 110. The plurality of user interfaces on the host side may reflect use aspects of the user. For example, a first user interface 132 on the host side (see FIG. 4) may be a graphic user interface on which contents are displayed such that simple selections are possible so that a user may hold and easily manipulate the remote controller 120 with one hand. A second user interface 134 on the host side (see FIG. 5) may be a graphic user interface on which a character input window or web browsers may be displayed so that a user may input characters while holding the remote controller 120 with two hands.

The remote controller 120 may include an input unit 121, a user interface control unit 122, a control signal generating unit 123, and a communication unit 124. The external appearance of the remote controller 120 is not limited to the examples shown herein.

The input unit 121 may be a touch screen that has a layered structure that includes a touch panel unit 1211 and an image panel unit 1212. The touch panel unit 1211 may be, for example, a capacitive touch panel, a resistive overlay touch panel, an infrared touch panel, and the like. The image panel unit 1212 may be, for example, a liquid crystal panel, an organic light-emitting panel, and the like. The image panel unit 1212 may display graphics of a user interface.

The user interface control unit 122 may provide a plurality of user interfaces on the controller side. Use aspects of the user regarding a remote controller may be reflected in the plurality of user interfaces on the controller side. For example, the first user interface 131 on the controller side (see FIG. 4) may be a keyboard that is formed on the remote controller 120 by combining number keys and function keys, and the second user interface 133 on the controller side (see FIG. 5) may be a QWERTY keyboard.

The control command generating unit 123 may generate a corresponding control command by matching coordinate values input to the touch panel unit 1211 and graphics displayed on the image panel unit 1212.

The communication unit 124 may transmit the control command generated in the control command generating unit 123 to the main body 110. For example, the communication unit 124 may correspond to the communication unit 114 such as an infrared communication module, a radio communication module, an optical communication module, and the like.

FIG. 4 illustrates an example of a user interface of the multimedia apparatus 100 of FIG. 1. In the example of FIG. 4, a user may manipulate the remote controller 120 by holding the same with one hand such as a right hand, RH.

Referring to FIG. 4, the user interface unit 122 on the controller side provides a first user interface 131, and the user interface control unit 115 of the main body 110 provides a first user interface 132 on the host side. Accordingly, graphics corresponding to the first user interface 131 on the controller side is displayed on the image panel unit of the input unit 121 of the remote controller 120, and graphics corresponding to the first user interface 132 on the host side is displayed on the display unit 111 of the main body 110.

For example, the first user interface 131 on the controller side and the first user interface 132 on the host side may be optimized for a user for manipulating the remote controller 120 by holding the same with one hand (RH). The first user interface 131 may correspond to a conventional remote controller in consideration of use aspects of a user (i.e., one-handed holding), and may be a graphic user interface that has a keyboard graphic formed by combining number keys and function keys optimized for one-handed input. Furthermore, the user interface 132 may be a graphic user interface on which contents are sequentially displayed so as to allow simple selection using just a simple keyboard of the remote controller 120.

That is, the display unit 111 may display contents based on the way that a user is holding the remote controller 120. In the example of FIG. 4, the user is holding the remote controller 120 with a single hand. Accordingly, the remote controller 120 can provide a user interface that may be easily manipulated by the user with a single hand. Furthermore, the display unit 111 may display contents thereon so that the contents can be easily navigated by a user manipulating the remote controller 120 with a single hand.

FIG. 5 illustrates another example of a user interface of the multimedia apparatus 100 of FIG. 1. Referring to FIG. 5, a user manipulates the remote controller 120 by holding the same with two hands (right and left hands, RH and LH).

Referring to FIG. 5, the user interface control unit 122 of the remote controller 120 provides a second user interface 133 on the controller side, and the user interface control unit 115 of the main body 110 provides a second user interface 134 on the host side. Accordingly, graphics corresponding to the second user interface 133 on the controller side is displayed on the image panel unit 1212 of the input unit 121 of the remote controller 120, and graphics corresponding to the second user interface 134 on the host side is displayed on the display unit 111 of the main body 110.

For example, the second user interface 133 on the controller side and the second user interface 134 on the host side may be optimized for a user manipulating the remote controller 120 by holding the same with two hands. The second user interface 133 on the controller side may be, for example, a graphic user interface that has a QWERTY keyboard graphic. Meanwhile, the second user interface 134 on the host side may be a user interface on which, for example, a character input window or a web browser is displayed so as to input characters into the same.

In some aspects, a selection key 1311 (shown in FIG. 4) may be provided on the first and second user interfaces 131 and 133 on the controller side so that one of the first user interface 131 on the controller side and the second user interface 133 on the controller side may be manually selected by direct manipulation of the user.

For example, if the user is holding the remote controller 120 with one hand, and if the remote controller 120 is in the state of the second user interface 133, the user may manually convert the user interface from the second user interface 133 to the first user interface 131 using the selection key 1311. In this example, a user interface displayed on the main body 110 may be automatically converted from the second user interface 134 to the first user interface 132.

As another example, if the user is holding the remote controller 120 with two hands, and if the remote controller 120 is in the state of the first user interface 131, the user may manually convert the user interface from the first user interface 131 to the second user interface 133 on the controller side using the selection key 1311. In this example, a user interface displayed on the main body 110 may be automatically converted from the first user interface 132 to the second user interface 134.

The first user interface 132 on the host side and the second user interface 134 on the host side may be user interfaces that match each other. For example, the first user interface 132 and the second user interface 134 may be based on the same operating system. Furthermore, the first user interface 132 and the second user interface 134 may have manipulation menu systems that correspond to each other. In this example, conversion between the first user interface 132 and the second user interface 134 may be a simple conversion of graphic images while maintaining a manipulation menu database, and thus a load consumed for conversion between user interfaces may be relatively small, and the conversion may be conducted relatively quickly. As another example, the first user interface 132 on the host side and the second user interface 134 on the host side may have different manipulation menu systems, and may be based on different operating systems.

While two user interfaces have been described above, three or more user interfaces may also be included. In this example, the user may select a user interface on one controller side (or on one host side), and conversion may be automatically conducted to a user interface on the corresponding host side (or the corresponding controller side).

In various aspects, the communication unit 124 of the remote controller 120 may transmit to the main body 110 information indicating the user interface that is being displayed on the remote controller 120. The information on the user interface that is being displayed on the remote controller 120 may be transmitted by the communication unit 124 to the communication unit 114 on the host side. Similarly, the communication unit 114 on the host side may transmit information on the user interface being displayed on the host side to the communication unit 124 of the remote controller 120. Accordingly, the display unit of the main body may automatically convert to the user interface corresponding to the user interface being displayed on the remote controller, and vice versa.

For example, when the user interface displayed on the display unit 111 changes (as shown in FIGS. 4 & 5) the communication unit 114 of the multimedia device communicates the change in the displayed user interface on the display unit 111 to the communication unit 124 of the remote controller.

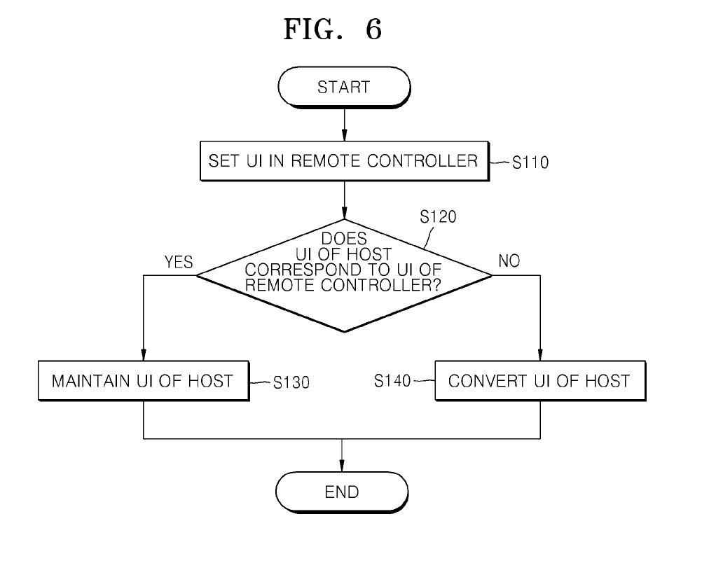

FIG. 6 illustrates an example of a method of providing a user interface in the multimedia apparatus 100 described with reference to FIGS. 1 through 5.

Referring to FIG. 6, in operation S110, a user interface UI of the remote controller 120 is set. For example, the user interface UI of the remote controller 120 may be the first user interface 131 optimized for one-handed holding on the controller side, or the second user interface 133 optimized for two-handed holding on the controller side. The first user interface 131 and the second user interface 133 may be set by user selection.

In operation S120, it is determined whether the user interface UI of the main body 110 corresponds to the user interface UI of the remote controller 120. If the user interface UI of the main body 110 corresponds to the user interface UI of the remote controller 120, the user interface UI of the main body 110 is maintained in operation S130. However, if the user interface UI of the main body 110 does not correspond to the user interface UI of the remote controller 120, the user interface UI of the main body 110 is converted to correspond to the user interface UI of the remote controller 120 in operation S140.

For example, if the user interface UI of the remote controller 120 is the first user interface 131, and the user interface UI of the main body 110 is the first user interface 132 corresponding to the first user interface 131 on the controller side, the user interface UI of the main body 110 is maintained. As another example, if the user interface UI of the remote controller 120 is the first user interface 131 but the user interface UI of the main body 110 is the second user interface 134, the second user interface 134 on the host side is converted to the first user interface 132 on the host side.

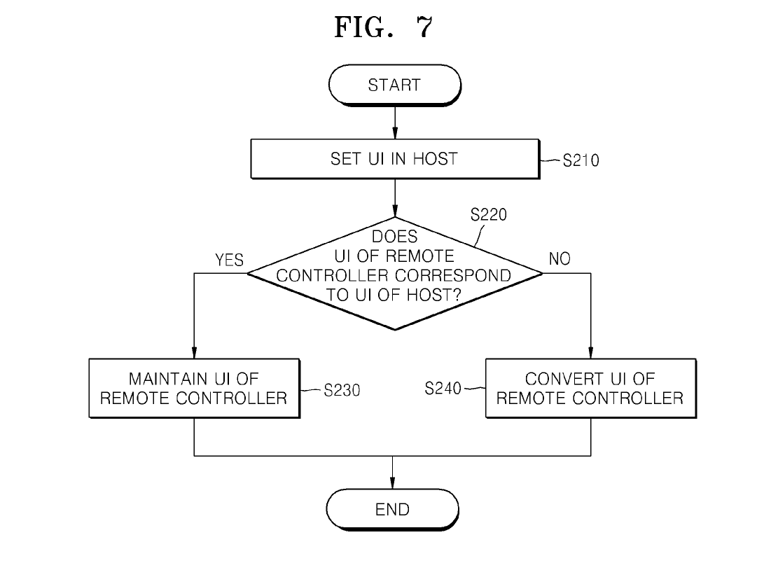

FIG. 7 illustrates an example of a method of providing a user interface in the multimedia apparatus 100 of FIG. 1.

Referring to FIG. 7, in operation S210, a user interface UI of the main body 110 is set. For example, the user interface UI of the main body 110 may be the first user interface 132 optimized for one-handed holding, or the second user interface 134 optimized for two-handed holding. The first user interface 132 and the second user interface 134 may be set by user selection.

In operation S220, it is determined whether the user interface UI of the remote controller 120 corresponds to the user interface UI of the main body 110. If the user interface UI of the remote controller 120 corresponds to the user interface UI of the main body 110, the user interface UI of remote controller 120 is maintained in operation S230. However, if the user interface UI of the remote controller 120 does not correspond to the user interface UI of the main body 110, the user interface UI of remote controller 120 is converted to correspond to the user interface UI of the main body 110 in operation S240. For example, if the user interface UI of the main body 110 is the first user interface 132, and the user interface UI of the remote controller 120 is the first user interface 131 corresponding to the first user interface 132 on the host side, the user interface UI of the remote controller 120 is maintained. On the other hand, if the user interface UI of the main body 110 is the first user interface 132 but the user interface UI of the remote controller 120 is the second user interface 133, the second user interface 133 is converted to the first user interface 131 on the controller side.

The example of providing a user interface described with reference to FIG. 6 may be understood as a priority mode of the user interface UI of the remote controller 120, and the example of providing a user interface described with reference to FIG. 7 may be understood as a priority mode of the user interface UI of the main body 110.

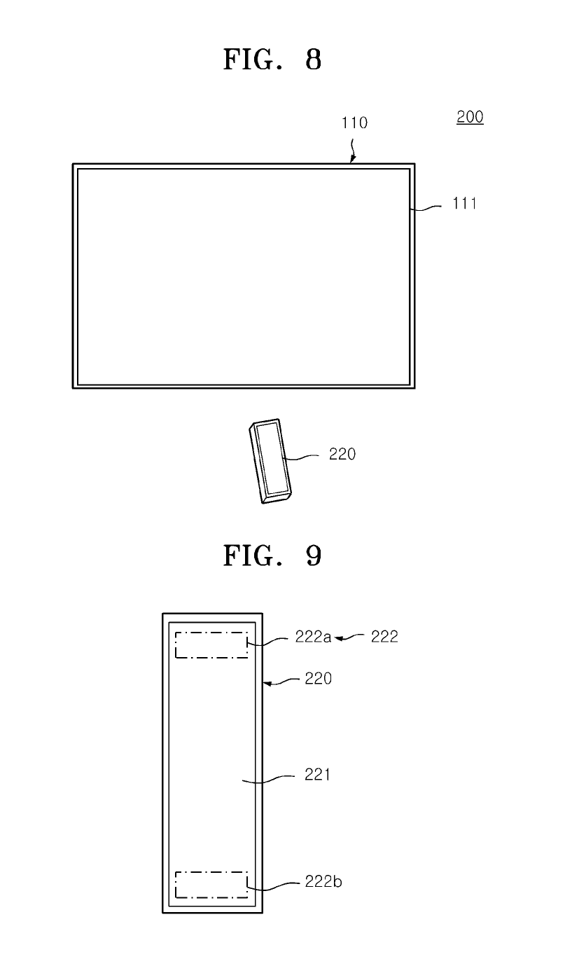

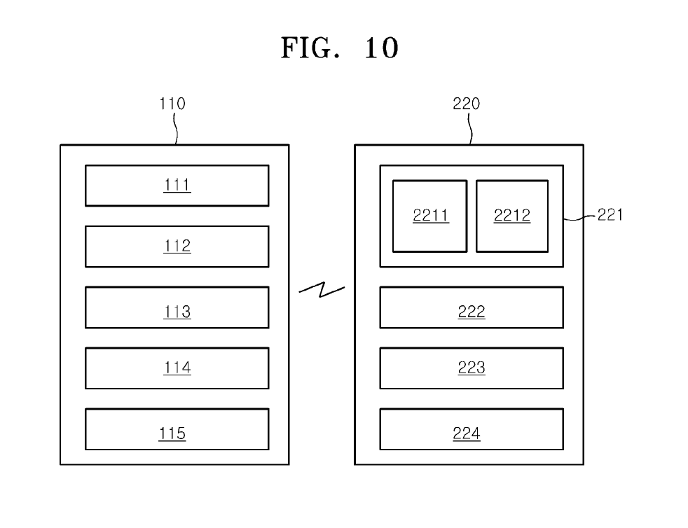

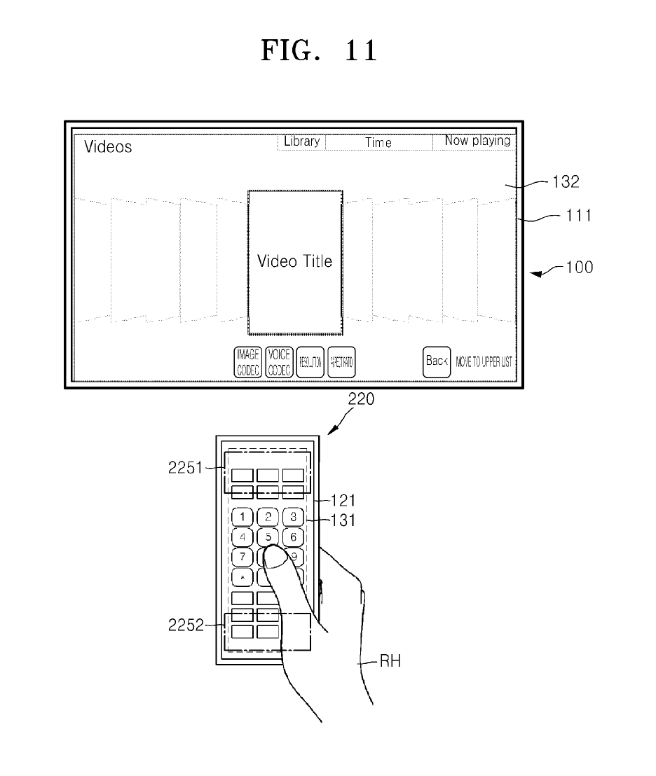

FIG. 8 illustrates an example of another multimedia apparatus 200. FIG. 9 illustrates an example of a remote controller 220 used with the multimedia apparatus 200 of FIG. 8. FIG. 10 illustrates an example of the multimedia apparatus 200 of FIG. 8.

Referring to FIGS. 8 through 10, the multimedia apparatus 200 includes a main body 110 and a remote controller 220 that controls the main body 110. The main body 110 is similar to the main body 110 described with reference to FIG. 1, and thus like elements are denoted with like reference numerals.

The remote controller 220 is the same as the remote controller 120 described with reference to FIGS. 1 through 10 except that the remote controller 220 includes a sensor unit 225 for detecting the manner in which a user is holding the remote controller. Thus, like elements are denoted with like reference numerals.

The sensor unit 225 may detect the way a user is holding the remote controller 220. For example, the sensor unit 225 may include first and second sensors 2251 and 2252 disposed near respective sides of the remote controller 220 in consideration of a way of the user holding the remote controller 220 with two hands or one hand. For example, to sense if the user is holding the remote controller 220 with two hands, the first and second sensors 2251 and 2252 may be arranged near two sides of a rear surface of the remote controller 220. The rear surface of the remote controller 220 refers to a back surface of the remote controller 220 where the input unit 121 is disposed.

For example, the first and second sensors 2251 and 2252 may be touch sensors for sensing a touch by hands of the user, proximity sensors for sensing the proximity of a hand of the user, pressure sensors sensing a pressure generated by the hand of the user, and the like. For example, the first and second sensors 2251 and 2252 may include an electrostatic touch sensor, a capacitive touch sensor, a resistive overlay touch sensor, an infrared touch sensor, and the like.

As another example, a touch of the user may be detected based on size or variation of resistance, capacitance or reactance of the first and second sensors 2251 and 2252. For example, impedance measured when the user holds the remote controller 220 with two hands and impedance measured when the user holds the remote controller 220 with one hand is different. Accordingly, whether the user is holding the remote controller 220 with two hands may be determined based on the size of detected impedance. As another example, if a change in impedance is detected from both the first and second sensors 2251 and 2252, it may be determined that the user is holding the remote controller 220 with two hands. As another example, if an impedance variation is detected from only one of the first and second sensors 2251 and 2252, it may be determined that the user is holding the remote controller 220 with one hand.

In this example, the user interface control unit 122 on the controller side may provide a user interface of the input unit 121 according to a signal detected using the sensor unit 225.

Referring to FIGS. 1-10, the control command generating unit 123 of the remote controller 120 may generate a control command and the communication unit 124 of the remote controller 120 may transmit the control command to the main body. The communication unit 114 of the main body 110 may receive a control command from the remote controller 120. For example, if the sensor unit 225 of the remote controller 120 detects a change of a user's holding, the control command generating unit 123 of the remote controller 120 may generate a conversion command, the communication unit 124 of the remote controller may transmit the conversion command to the main body 110, and then the communication unit 114 of the main body 110 may receive the conversion command from the remote controller 120.

Similarly, the main body 110 may inform the remote controller 120 of a change in the display unit 111. For example, the communication unit 114 of the main body 110 may transmit a conversion command to the communication unit 124 of the remote controller 120.

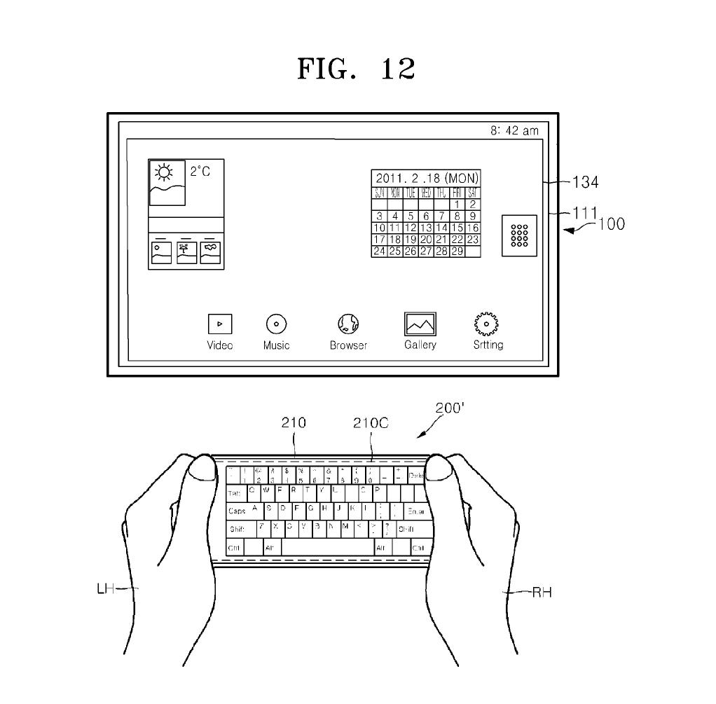

FIG. 11 illustrates an example of a user interface of the multimedia apparatus of FIG. 8.

Referring to FIG. 11, the first and/or second sensors 2251 and/or 2252 may detect whether the user holds the remote controller 220 with one hand or with two hands. For example, when the user holds a middle end and a lower end of the remote controller 220 with a hand (for example, with a right hand (RH)) to input data by pressing the input unit 121 with the thumb, the right hand (RH) of the user may contact the second sensor 2252 of the sensor unit 225. In this example, if only one of the first and second sensors 2251 and 2252 detects a contact of the user, the user interface control unit 122 may control a user interface of the input unit 121 via the first user interface 131 that is optimized for one-handed input.

FIG. 12 illustrates another example of a user interface of the multimedia apparatus of FIG. 8.

Referring to FIG. 12, when the user holds two sides of the remote controller 220 with two hands (LH and RH) to input data by pressing the input unit 121 with the thumbs, the left hand (LH) of the user may contact the first sensor 2251 of the sensor unit 225 and the right hand (RH) of the user may contact the second sensor 2252 of the second sensor unit 210. Accordingly, the first and second sensors 2251 and 2252 may detect a contact of the two hands of the user, and the user interface control unit 122 may control a user interface environment of the input unit 121 via the second user interface 133 that is optimized for two-handed input.

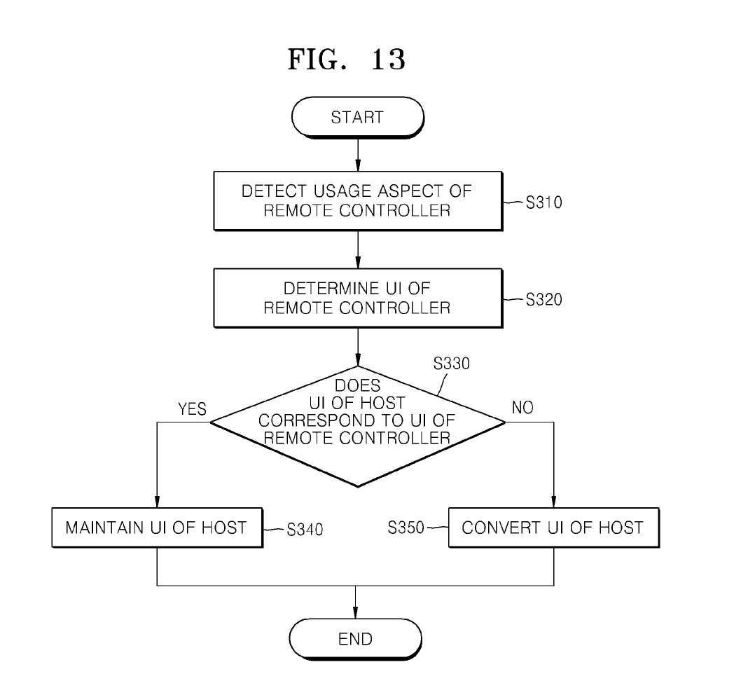

FIG. 13 illustrates an example of a method of providing a user interface in the multimedia apparatus 200 of FIG. 8.

Referring to FIG. 13, the manner in which the user is holding the remote controller 220 is detected in operation S310, and a user interface UI of the remote controller 220 is determined based on the detected manner with which the user is holding the remote controller 220 in operation S320. For example, if the user is holding the remote controller 220 with one hand, the first user interface 131 that is optimized for one-handed holding is set as the user interface UI of the remote controller 220. If the user is holding the remote controller 220 with two hands, the second user interface 133 that is optimized for two-handed holding is set as the user interface UI of the remote controller 220.

In operation S330, it is determined whether the user interface UI of the main body 110 corresponds to the user interface UI of the remote controller 220. For example, if the user interface UI of the main body 110 corresponds to the user interface UI of the remote controller 220, the user interface UI of the main body 110 is maintained in operation S340. As another example, if the user interface UI of the main body 110 does not correspond to the user interface UI of the remote controller 220, the user interface UI of the main body 110 is converted to correspond to the user interface UI of the remote controller 220 in operation S350.

In the example above, the sensor unit 225 includes first and second sensors 2251 and 2252 for detecting the number of hands holding the remote controller, however, the examples are not limited thereto. For example, the sensor unit 225 may include at least three sensors to detect various holding ways of the user. Furthermore, the sensor unit 225 may include a sensor such as a gravity sensor sensing a direction of the remote controller or a geomagnetic sensor detecting a use aspect of the user such as a horizontal state or a vertical state of the remote controller 220, and provide a corresponding user interface.

In various examples, while only a touch screen is described as the input unit 121 of the remote controller 120 or 220, instead of the touch screen, a button inputting unit to which a hologram layer that is differently displayed according to use aspects of the user may also be included. For example, the button inputting unit attached with a hologram layer may form holograms using the characteristic that the outward appearance of a hologram varies from the eyes of the user such that an image of the first user interface 131 optimized for one-handed holding is displayed on the outward appearance of the hologram viewed by holding with one hand, and that an image of the second user interface 133 optimized for two-handed holding is displayed on the outward appearance of the hologram viewed by holding with two hands.

In some examples, an additional input unit may be further included in the input unit 121 of the remote controller 120 or 220. For example, the remote controller 120 or 220 may further include a motion sensor (not shown) sensing motion of the remote controller 120 or 220 such as a two-axis or three-axis inertial sensor. In this example, instead of the selection key 1311 (see FIG. 4) with which a user interface may be converted, conversion of the user interface may be performed according to movement of a predetermined pattern of the remote controller 120 or 220. For example, if the user rotates the remote controller 120 or 220 several times, the control signal generating unit 122 may generate a conversion command, and the user interface control unit 115 on the host side may convert the first user interface 132 on the host side to the second user interface 134 on the host side, or the other way around.

In digital apparatuses such as smart TVs, a user environment UI/UX is an important issue. Smart TVs may provide not only broadcasting contents but also various internet-based contents that are available on a conventional personal computer such as internet web surfing, electronic mails, games, photos, music, and videos.

However, if the supply of such various contents via the smart TVs causes inconvenience to the user, utility of smart TVs will be degraded. In this regard, various aspects herein are directed towards a remote controller and a multimedia device that may improve user convenience based on user interfaces displayed on a remote controller and on a display of a multimedia device.

According to various aspects, a main body of a multimedia device may detect a user interface displayed on a remote controller and maintain or change a user interface displayed on a display of the multimedia device to correspond to the user interface displayed on the remote controller. Likewise, the remoter controller may detect a user interface that is displayed by a display unit connected to a main body of a multimedia device, and the remote controller may maintain or change a user interface displayed on the remote controller to correspond to the user interface displayed on the display unit connected to the main body.

Accordingly, a user interface displayed as a keypad on a remote controller may be synchronized with a user interface displayed as visual data on a display unit. Accordingly, a more convenient user experience is possible.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a user interface, the apparatus comprising:
a main body configured to provide a plurality of user interfaces on a display; and
a remote controller configured to provide a plurality of user interfaces on the remote controller,
wherein, in response to a user interface on the remote controller being selected, the main body is configured to provide a user interface on the display that corresponds with the selected user interface on the remote controller.

2. The apparatus of claim 1, wherein the main body comprises:
a display unit which includes the display;
a communication unit configured to receive a control command from the remote controller; and
a user interface control unit configured to provide a graphic user interface to the display unit.

3. The apparatus of claim 1, wherein the remote controller comprises:
an input unit configured to receive input from a user;
a user interface control unit disposed on a surface of the remote controller and configured to provide a plurality of user interfaces;
a control command generating unit configured to generate a control command according to a signal of a user input to the input unit; and
a communication unit configured to transmit the control command to the main body.

4. The apparatus of claim 3, wherein the input unit comprises a touch screen.

5. The apparatus of claim 1, wherein the remote controller comprises a selection key configured to receive input from a user to manually select a user interface that is to be provided on the remote controller from among the plurality of user interfaces.

6. The apparatus of claim 1, further comprising a sensor unit configured to detect a manner in which a user is holding the remote controller, wherein the user interface on the remote controller is converted or maintained based on the manner in which the user is holding the remote controller.

7. The apparatus of claim 6, wherein the user interface control unit of the remote controller is configured to provide a first user interface including a graphic of a keyboard formed by combining number keys and function keys, in response to detecting that the user is holding the remote controller with one hand, and the user interface control unit of the remote controller is configured to provide a second user interface including a graphic of a QWERTY keyboard of the remote controller, in response to detecting that the user is holding the remote controller with two hands.

8. The apparatus of claim 1, wherein the plurality of user interfaces provided by the main body comprise a first user interface and a second user interface which are provided based on the same operating system.

9. The apparatus of claim 8, wherein the first user interface and the second user interface provided by the main body comprise manipulation menu systems corresponding to each other.

10. The apparatus of claim 8, wherein the remote controller further comprises a motion sensor configured to detect motion of the remote controller, and in response to the motion sensor detecting movement of the remote controller satisfying a predetermined conversion pattern, a user interface provided by the main body is converted between the first user interface and the second user interface.

11. The apparatus of claim 1, wherein the main body comprises a smart television.

12. A method of providing a user interface, the method comprising:
selecting and providing one of a plurality of user interfaces on the remote controller; and
providing, by a main body, one of a plurality of user interfaces on a display unit,
wherein the main body provides the user interface on the display to correspond to the selected user interface provided on the remote controller.

13. The method of claim 12, wherein the user interface on the remote controller is selected manually by direct manipulation of a user.

14. The method of claim 12, wherein one of the plurality of user interfaces on the remoter controller is selected automatically based on a manner in which a user is holding the remote controller.

15. The method of claim 14, wherein the selecting and providing of the user interface on the remote controller comprises:
detecting whether the user is holding the remote controller with one hand or with two hands; and
maintaining the user interface of the remote controller or converting the user interface of the remote controller to another user interface from among the plurality of user interfaces of the remoter controller based on whether the user is holding the remote controller with one hand or with two hands.

16. The method of claim 15, wherein a first user interface on the remote controller comprises a graphic of a keyboard formed by combining number keys and function keys, in response to detecting that he user is holding the remote controller with one hand, and a second user interface on the remote controller comprises a graphic of a QWERTY keyboard, in response to detecting that the user is holding the remote controller with two hands.

17. The method of claim 11, wherein the plurality of user interfaces provided by the main body comprise a first user interface and a second user interface both of which are provided based on the same operating system.

18. The method of claim 17, wherein the first user interface and the second user interface comprise manipulation menu systems corresponding to each other.

19. The method of claim 17, further comprising converting between the first user interface and the second user interface in response to motion of the remote controller satisfying a predetermined conversion pattern.

20. An apparatus for providing a user interface, the apparatus comprising:
a main body configured to provide a plurality of user interfaces on a display; and
a remote controller configured to provide a plurality of user interfaces on the remote controller,
wherein, in response to a user interface provided by the main body on the display being selected, the remote controller is configured to provide a user interface on the remoter controller that corresponds with the selected user interface provided by the main body on the display.
